(19) United States
(12) Patent Application Publication
(10) Pub. No.: US 2025/0164025 A1
(43) Pub. Date: May 22, 2025

(54) Fine Ceramics Valve with Safety Device

(71) Applicant: GEANN INDUSTRIAL CO.,LTD., CHANG HUA HSIEN (TW)

(72) Inventor: Hsiang-Shih Wang, CHANGHUA CITY (TW)

(73) Assignee: GEANN INDUSTRIAL CO.,LTD., CHANG HUA HSIEN (TW)

(21) Appl. No.: 18/513,928

(22) Filed: Nov. 20, 2023

(51) Int. Cl. F16K 27/02; F16K 25/00; F16K 31/50

(52) U.S. Cl. CPC F16K 27/02; F16K 25/00; F16K 31/50

(57) ABSTRACT

A precision ceramic valve with the safety device includes a valve and a precision ceramic valve core. The precision ceramic valve core has excellent performance and durability, which can avoid friction loss in the rotation control and greatly improve the closing function. The leakproof effect not only maintains the smoothness of opening but also improves the practicality of the structure. The precision ceramic valve core cooperates with the fitting feet of the shaft bolt and the limiting section and the rotary control section inside the body. In the closed state, the shaft bolt must be pressed to rotary open, and when the rotary control is closed from the open state, the shaft bolt can also automatically rebound and position, effectively avoiding the concern that the precision ceramic valve core be easily opened by the rotary control, and greatly reducing the risk of structural use that enhance the safety.

### BACKGROUND OF THE INVENTION

### Field of the Invention

This invention relates to a precision ceramic valve, in particular to a precision ceramic valve with a safety device.

### Description of the Related Art

The gas valve structure of gas cylinders currently on the market generally has one end connected to the gas cylinder and the other end connected to a switch. In addition, a lateral interface extends laterally from the gas valve, and the lateral interface is connected to the gas cylinder and has an internal thread used for connecting the fluid pipe joint. The rotation of the switch controls the connection or disconnection of the fluid pipe joint with the gas cylinder.

Taiwan Patent No. M404309 discloses a commonly used switch valve for high-pressure gas cylinders. A switching valve for a high-pressure gas cylinder, comprising: a valve body, wherein a main flow channel is formed in the valve body, an opening is formed in the top of the main flow channel, a filling port is formed in the position, in the approximately middle section, of the valve port in the radial direction, a valve base part is arranged at the bottom of the valve body, and at least one positioning groove penetrating through the main flow channel is formed in the outer wall of the lower part of the opening of the valve body in the radial direction; a control device, connecting a control rod to the top opening of the main flow channel, wherein the bottom of the control rod is provided with a plug which is accommodated in the main flow channel, and the top of the control rod is connected with a handle exposed out of the main valve body; the flange part below the plug is radially sleeved with at least one O-ring which forms an airtight effect with the inner wall of the main flow channel; and at least one stop member inserted and fixed in the positioning slot; the rotating handle and the control rod drive the plug to axially move in the main flow channel, so that the bottom of the flange portion of the plug shields the valve port, the communication between the main flow channel and the filling port is cut off, or the top of the flange portion of the plug abuts against the stop member, so that the handle cannot continue to drive the control rod to rotate.

It is known that there are still some shortcomings in the above-mentioned conventional structure. The conventional switch valve mainly achieves the on/off by using the plug of the control rod to shield the valve port. The O-ring on the flange and the inner wall of the main flow channel form an airtight effect. However, when the control rod frequently reciprocates, since the plug is made of metal, it is easy to cause wear and clearance due to friction, causing the valve port to be blocked. Since the O-ring is made of plastic or rubber, the plug is also prone to wear and tear due to extrusion and friction, causing the plug to be unable to effectively achieve the airtight effect of the main flow channel and the purpose of shielding and closing the valve port. Lack of structural durability, thereby increasing the risk of gas leakage.

In addition, the conventional switch valve only achieves the purpose of opening and closing through simple forward and reverse movements, so that the switch valve is easily opened by the rotation control, which lacks safety.

### SUMMARY OF THE INVENTION

The technical problem to be solved by the present invention is to provide a precision ceramic valve with a safety device in view of the above-mentioned deficiencies in the prior art.

In order to achieve the above object, the present invention provides a precision ceramic valve with a safety device that includes: a valve, which is hollow and has a flow channel, a valve chamber, an inlet end, and an outlet end connected to the flow channel. The valve chamber is located at an upper end of the flow channel, an inlet path is formed at the bottom of the extension section to communicate with the flow channel and the inlet end, and an outlet path is provided at the side of the bottom of the extension section to communicate with the outlet end. A precision ceramic valve core is assembled in the valve chamber, the precision ceramic valve core has a body, a shaft bolt, a shaft bolt connecting seat, a rectifier seat, a cut control ceramic sheet, an inlet ceramic sheet, and a leakproof gasket. The body is provided with a through groove through the upper and lower ends, the upper half of the through groove is provided with a limiting section, a rotary control section, and an expansion section between the limiting section and the rotary control section. Two limiting grooves are recessed at two symmetrical positions of the limiting section, and a retaining wall is formed at the upper end of the two limiting grooves. Two rotary control grooves are recessed in two symmetrical positions of the rotation control section, and two rotary control blocks are formed between the two rotary control grooves. One end of the two rotary control grooves is connected to the two limit grooves. The other end of the two rotary control grooves faces the bottom surface of the limiting section, and the inner diameter of the rotary control groove is the same as that of the limiting groove. An inlet is formed at the bottom of the through groove, and two outlets and two recessed grooves are provided at symmetrical positions of the lower half of the through groove. The inner wall of the inlet forms an expansion section, and the inner wall of the expansion section is provided with a ring convex rib. The shaft bolt is passed through the through groove from bottom to top, the bottom end of the shaft bolt is recessed with a through groove to accommodate a spring, two fitting feet are formed at the bottom end of the shaft bolt extending along the edge of the through groove, and the outer surfaces of the two fitting feet exceed the surface of the shaft bolt to form a resisting portion. The outer diameter of the resisting section is larger than the inner diameter of the limiting section and is smaller than the inner diameter of the limiting groove and the rotary control groove. The shaft bolt connection seat is provided with two ring diameters on the outer diameter and is covered with two leakproof rings. The top of the shaft bolt connection seat has a connection part, the connection part is hollow with a slot for accommodating the other end of the spring and is provided with two fitting slots on the outer periphery to engage with the two fitting feet of the shaft bolt. The bottom end of the shaft bolt connection seat is further provided with a driving bump. The rectifier seat is provided with a linked through hole through the upper surface to connect with the driving bump, and two insert parts protrude from the periphery of the bottom surface. The upper surface of the cut control ceramic sheet is provided with a linked slot that fits and interlocks with the drive bump. Two insert sides are formed symmetrically on both sides for two insert parts to snap together, and the bottom of the cut control ceramic sheet is symmetrically provided with two through slots and is provided with two convex blocks on the outer peripheral surface. The inlet ceramic sheet 26 is positioned by fitting the two convex blocks with the two recessed grooves of the through groove, and is close to the bottom of the cut control ceramic sheet. The leakproof gasket is a tight plug located at the inlet of the through groove.

Preferably, the outer diameter of the shaft bolt connection seat is larger than the inner diameter of the rotation control section, thereby limiting the shaft bolt connection seat to the bottom of the rotation control section. A lubricating washer is further provided between the shaft bolt connection seat and the rotary control section.

Preferably, the inner wall of the inlet forms an expansion section, and the inner wall of the expansion section is provided with a ring convex rib. The leakproof gasket is provided with an annular groove on the outer diameter and is positioned through the annular groove and the ring convex rib.

Preferably, an inner diameter of the valve chamber is reduced from top to bottom to form an internal thread section and an extension section, an inlet path is formed at the bottom of the extension section to communicate with the flow channel and the inlet end, and an outlet path is provided at the side of the bottom of the extension section to communicate with the outlet end. The outer diameter of the body decreases sequentially from top to bottom to form a nut section, an external thread section, a leakproof section, and an inlet/outlet section. The leakproof section is provided with at least two annular grooves and at least two leakproof rings embedded in the two annular grooves. The side of the inlet/outlet section is connected to the through groove through the outlet.

Preferably, a trench is carved on the outer diameter surface of the nut section, marking the external thread section of the body as the left-hand thread.

Comparing the effectiveness of the prior art: the precision ceramic valve core used in the present invention has excellent performance and durability. It can not only avoid friction loss in the rotation control operation, greatly improve the leakage prevention effect when closing, but also maintain the smoothness of opening that improves the practicality of the structure.

The precision ceramic valve core cooperates with the fitting feet of the shaft bolt and the limiting section and the rotary control section inside the body. In the closed state, the shaft bolt must be pressed to rotary open, and when the rotary control is closed from the open state, the shaft bolt can also automatically rebound and position, effectively avoiding the concern that the precision ceramic valve core be easily opened by the rotary control, and greatly reducing the risk of structural use that enhance the safety.

### BRIEF DESCRIPTION OF THE DRAWINGS

The following drawings are merely examples for illustrative purposes according to various disclosed embodiments and are not intended to limit the scope of the present disclosure.

FIG. 1 is a perspective view of the present invention.

FIG. 2 is an exploded view of the present invention.

FIG. 3 is an exploded view of the precision ceramic valve core of the present invention.

FIG. 4 is an assembled cross-sectional view of the present invention.

FIG. 5 is a cross-sectional view of the precision ceramic valve core assembly of the present invention.

FIG. 6 is a cross-sectional view of the precision ceramic valve core of the present invention from another angle.

FIG. 7 is a cross-sectional view of the pressing action of the precision ceramic valve core of the present invention.

FIG. 8 is a cross-sectional view of the precision ceramic valve core of the present invention after the rotary control is pressed.

FIG. 9 is a schematic diagram of the opening of the present invention.

### DETAILED DESCRIPTION OF THE INVENTION

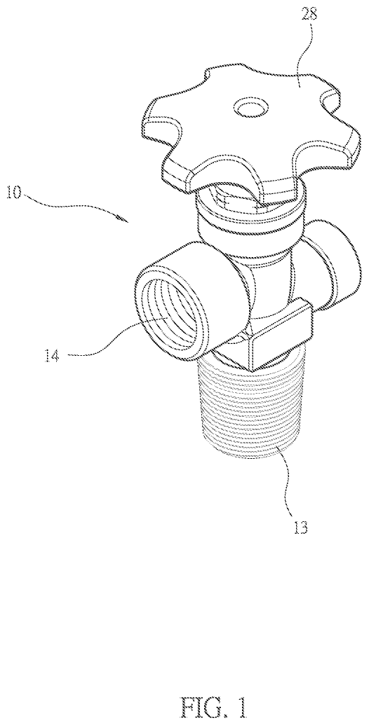

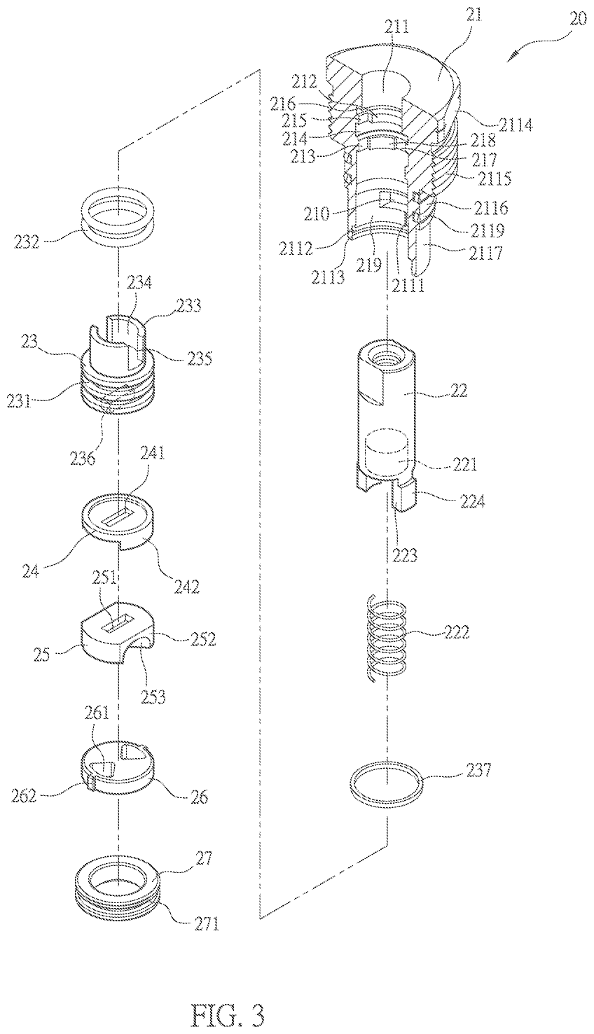

As shown in FIGS. 1-4, a precision ceramic valve with a safety device includes: a valve 10, which is hollow and has a flow channel 11, a valve chamber 12, an inlet end 13, and an outlet end 14 are connected to the flow channel 11. The valve chamber 12 is located at an upper end of the flow channel 11, and an inner diameter of the valve chamber 12 is reduced from top to bottom to form an internal thread section 121 and an extension section 122, an inlet path 123 is formed at the bottom of the extension section 122 to communicate with the flow channel 11 and the inlet end 13, and an outlet path 124 is provided at the side of the bottom of the extension section 122 to communicate with the outlet end 14. A precision ceramic valve core 20 is assembled in the valve chamber 12, the precision ceramic valve core 20 has a body 21, a shaft bolt 22, a shaft bolt connecting seat 23, a rectifier seat 24, a cut control ceramic sheet 25, an inlet ceramic sheet 26, and a leakproof gasket 27. The body 21 is provided with a through groove 211 through the upper and lower ends, the upper half of the through groove 211 is provided with a limiting section 212, a rotary control section 213, and an expansion section 214 between the limiting section 212 and the rotary control section 213. Two limiting grooves 215 are recessed at two symmetrical positions of the limiting section 212, and a retaining wall 216 is formed at the upper end of the two limiting grooves 215. Two rotary control grooves 217 are recessed in two symmetrical positions of the rotation control section 213, and two rotary control blocks 218 are formed between the two rotary control grooves 217. One end of the two rotary control grooves 217 is connected to the two limit grooves 215. The other end of the two rotary control grooves 217 faces the bottom surface of the limiting section 212, and the inner diameter of the rotary control groove 217 is the same as that of the limiting groove 215. An inlet 219 is formed at the bottom of the through groove 211, and two outlets 210 and two recessed grooves 2111 are provided at symmetrical positions of the lower half of the through groove 211. The inner wall of the inlet 219 forms an expansion section 2112, and the inner wall of the expansion section 2112 is provided with a ring convex rib 2113. The outer diameter of the body 21 decreases sequentially from top to bottom to form a nut section 2114, an external thread section 2115, a leakproof section 2116, and an inlet/outlet section 2117. A trench 2118 is carved on the outer diameter surface of the nut section 2114, marking the external thread section 2115 of the body 21 as the left-hand thread. The leakproof section 2116 is provided with at least two annular grooves and at least two leakproof rings 2119 embedded in the two annular grooves. The side of the inlet/outlet section 2117 is connected to the through groove 211 through the outlet 210. The shaft bolt 22 is passed through the through groove 211 from bottom to top, the bottom end of the shaft bolt 22 is recessed with a through groove 221 to accommodate a spring 222, two fitting feet 223 are formed at the bottom end of the shaft bolt 22 extending along the edge of the through groove 221, and the outer surfaces of the two fitting feet 223 exceed the surface of the shaft bolt 22 to form a resisting portion 224. The outer diameter of the resisting section 224 is larger than the inner diameter of the limiting section 212 and is smaller than the inner diameter of the limiting groove 215 and the rotary control groove 217. The shaft bolt connection seat 23 is provided with two ring diameters 231 on the outer diameter and is covered with two leakproof rings 232. The top of the shaft bolt connection seat 23 has a connection part 233, the connection part 233 is hollow with a slot 234 for accommodating the other end of the spring 222 and is provided with two fitting slots 235 on the outer periphery to engage with the two fitting feet 223 of the shaft bolt 22. The bottom end of the shaft bolt connection seat 23 is further provided with a driving bump 236. The outer diameter of the shaft bolt connection seat 23 is larger than the inner diameter of the rotation control section 213, thereby limiting the shaft bolt connection seat 23 to the bottom of the rotation control section 213. A lubricating washer 237 made of Teflon is further provided between the shaft bolt connection seat 23 and the rotary control section 213. The rectifier seat 24 is provided with a linked through hole 241 through the upper surface to connect with the driving bump 236, and two insert part 242 protrude from the periphery of the bottom surface. The upper surface of the cut control ceramic sheet 25 is provided with a linked slot 251 that fits and interlocks with the drive bump 236. Two insert sides 252 are formed symmetrically on both sides for two insert parts 242 to snap together, and the bottom of the cut control ceramic sheet 25 is symmetrically provided with two through slots 253. The inlet ceramic sheets 26 is provided with two symmetrical inlet holes 261, and is provided with two convex blocks 262 on the outer peripheral surface. The inlet ceramic sheet 26 is positioned by fitting the two convex blocks 262 with the two recessed grooves 2111 of the through groove 211, and is close to the bottom of the cut control ceramic sheet 25. The leakproof gasket 27 is a tight plug located at the inlet 219 of the through groove 211, the leakproof gasket 27 is provided with an annular groove 271 on the outer diameter and is positioned through the annular groove 271, and the ring convex rib 2113.

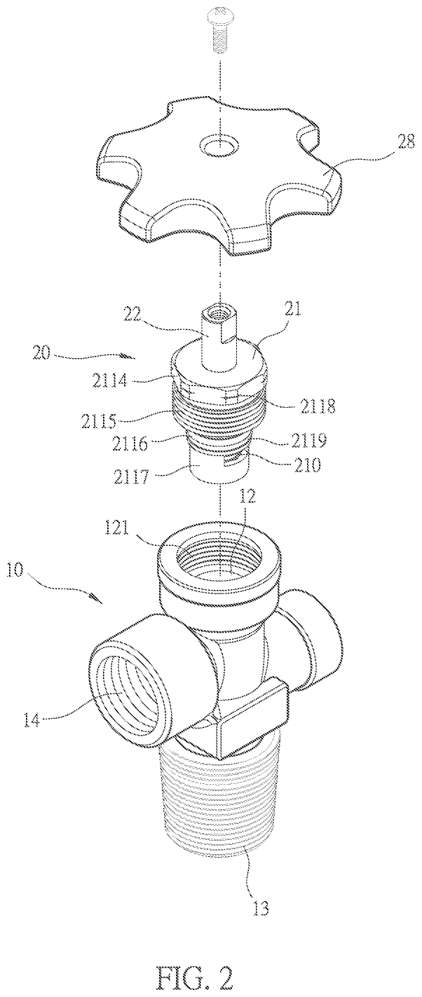

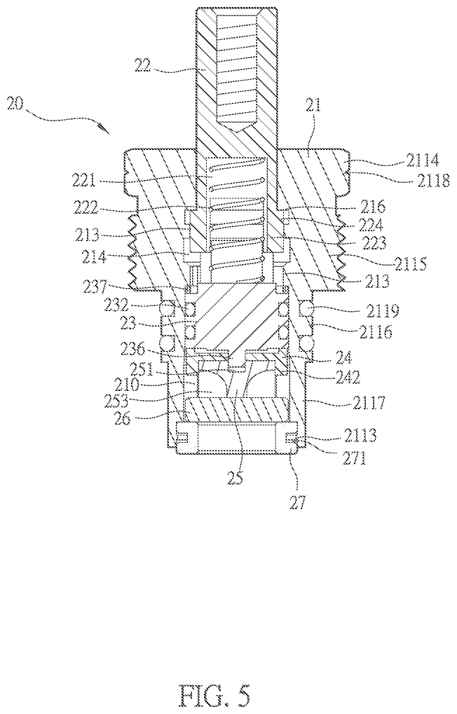

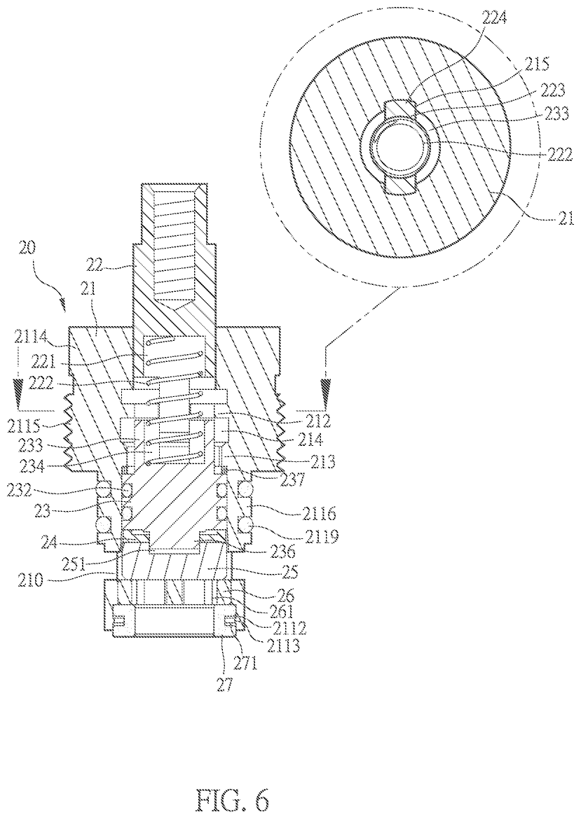

FIGS. 2-6 illustrate the structure of the present disclosure. The precision ceramic valve core 20 is first composed and then installed in the valve chamber 12 of the valve 10. The shaft bolt 22 is assembled into the through groove 211 of the body 21 from bottom to bottom, the top end of the shaft bolt 22 passes out of the nut section 2114, and the two fitting feet 223 are relatively limited by the outer resisting section 224 in the two limiting grooves 215 of the limiting sections 212. At the same time, the resisting section 224 is pressed upward against the retaining wall 216 of the limiting section 212 to limit positioning. The spring 222 is accommodated in the space between the slot 234 of the shaft bolt connection seat 23 and the through groove 211 of the shaft bolt 22. The connection part 233 passes through the rotary control section 213 and is connected with the two fitting feet 223 by the two fitting slots 235. The shaft bolt connecting seat 23 is limited to the bottom end of the rotary control section 213, and the lubricating washer 237 is interposed between the shaft bolt connection seat 23 and the bottom end of the rotary control section 213. The rectifier seat 24 places the insert part 242 downward into the through groove 211, and is connected to the drive bump 236 of the shaft bolt connection seat 23 through the linked through hole 241. The cut control ceramic sheet 25 is placed with the two through slot 253 facing down In the through groove 211. The linked slot 251 of the cut control ceramic sheet 25 is connected with the drive bump 236, and the two insert side 252 of the cut control ceramic sheet 25 are locked with the insert part 242 of the rectifier base 24 to further align the cutting control ceramic piece 25 with the two outlets 210 of the through slot 211. The inlet ceramic sheets 26 is fixed to the recessed groove 2111 of the through groove 211 by two convex blocks 262, and is pressed upward against the bottom surface of the cut control ceramic sheet 25. Finally, the leakproof gasket 27 is embedded in the expansion section 2112 of the inlet 219. One end of the leakproof gasket 27 is fastened against the bottom surface of the inlet ceramic sheets 26. Furthermore, the annular groove 271 of the outer diameter and the ring convex rib 2113 of the expansion section 2112 limit the positioning, and the other end extends beyond the inlet 219. Then, the precision ceramic valve core 20 is installed in the valve chamber 12 of the valve 10. The body 21 is positioned by using the external thread section 2115 and the internal thread section 121, and the nut section 2114 is exposed above the valve chamber 12. The inlet/outlet section 2117 is connected with the outlet path 124, and the leakproof gasket 27 at the bottom of the body 21 is close to the end edge of the inlet path 123. The leakproof section 2116 is close to the inner diameter surface of the extension section 122, and a knob 28 can be assembled at the top of the shaft bolt 22 to complete the process of assembling the precision ceramic valve core 20 and the valve 10.

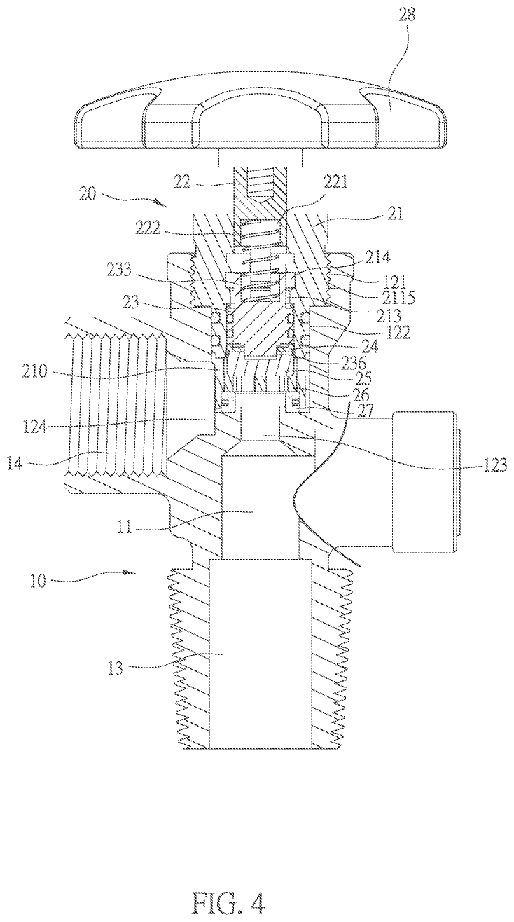

FIGS. 4-6 illustrate the use of the present disclosure. When the precision ceramic valve core 20 is not operated, the through slot 253 of the cut control ceramic sheet 25 is staggered with the outlet 210 and the inlet hole 261 of the inlet ceramic sheets 26 to form a closed state. The shaft bolt 22 is normally supported by the spring 222, and the two fitting feet 223 are limited to the two limiting grooves 215 of the limiting section 212 and cannot be rotated so that the precision ceramic valve core 20 will not be accidentally touched and easily rotated to an open state. It can be especially used in gas control valves or fluid control valves to achieve the safety of controlled use.

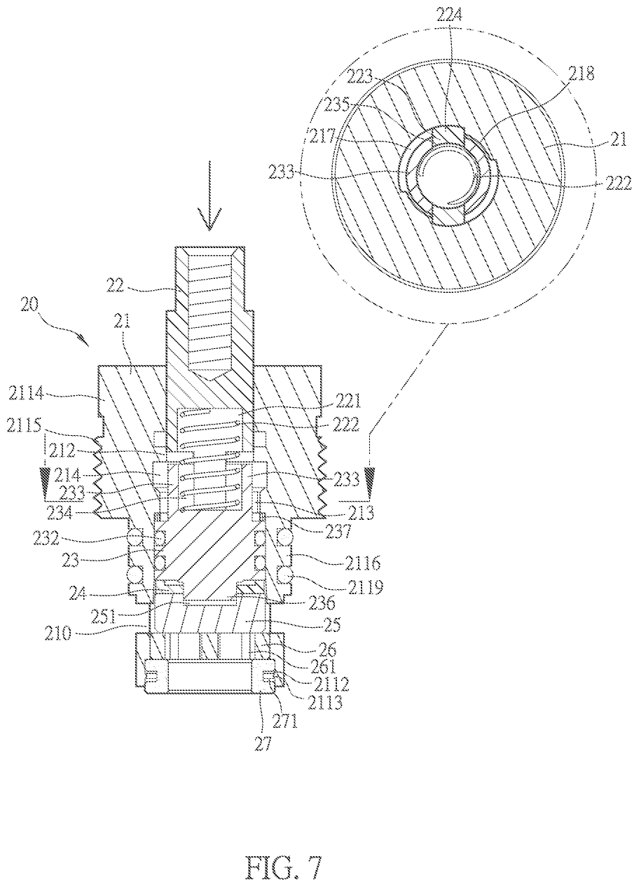

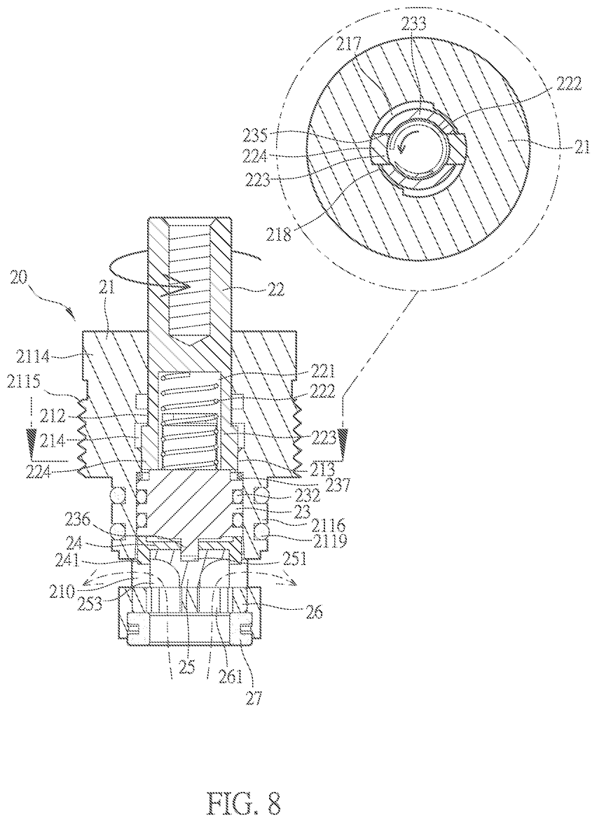

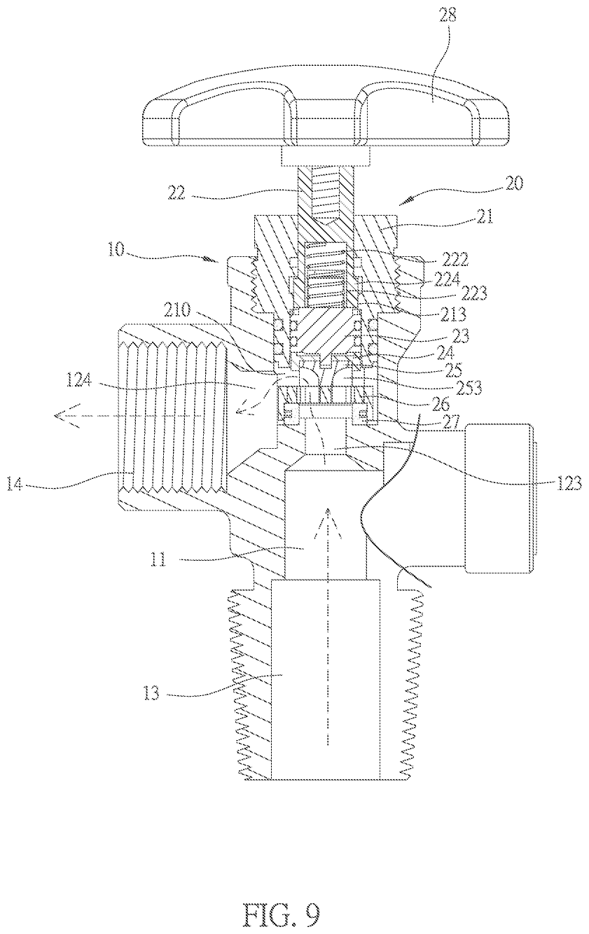

FIGS. 7-9 illustrate the actual operation of the present disclosure.

When controlling the precision ceramic valve core 20 to form the open state, first press the shaft bolt 22 downward, so that the two fitting feet 223 at the bottom of the shaft bolt 22 can move downward from the restriction of the two limiting grooves 215, and simultaneously extend into the two rotary control grooves 217 of the rotary control section 213. Then maintain the pressed state of the shaft bolt 22 so that the two fitting feet 223 can rotate counterclockwise along the two rotary control grooves 217 and drive the shaft bolt connection seat 23 to rotate, and further link the rectifier seat 24 and the cut control ceramic sheet 25 through the driving bump 236. The rectifier base 24 also utilizes two insert parts 242 to interlock with the insert side 252 of the cut control ceramic sheet 25, so that the through slot 253 of the cut control ceramic sheet 25 after rotation is communicated with the inlet hole 261 of the inlet ceramic sheets 26 and the two outlets 210 of the body 21. The gas or fluid connected to the inlet end 13 can sequentially pass through the two outlets 210 and flow to the outlet end 14 of the valve 10, and form the open state of the valve 10. When the shaft bolt 22 is rotated and the resisting section 224 of the two fitting feet 223 respectively abuts the other ends of the two rotary control blocks 218 of the rotary control section 213, the shaft bolt 22 is rotated 90 degrees to form the fully open state of the precision ceramic valve core 20. After the shaft bolt 22 is rotated counterclockwise, the two fitting feet 223 are relatively located below the limiting section 212 and are staggered with the limiting groove 215. When the shaft bolt 22 is loosened, the two fitting feet 223 are limitedly abutted the bottom end of the limiting section 212 because the outer diameter of the resisting section 224 is larger than the inner diameter of the limiting section 212. The shaft bolt 22 cannot be pushed back by the spring 222 and maintains a sinking state, so as to clearly indicate that the valve 10 is in an open state, thereby avoiding trouble and danger in use caused by errors in judgment and operation.

On the contrary, when the shaft bolt 22 is rotated clockwise to form the closed state of the precision ceramic valve core 20, the two fitting feet 223 of the shaft bolt 22 will be reset to face the limiting groove 215 of the limiting section 212, so that it can automatically rebound and rise through the pushing of the spring 222, and further embed in the limiting groove 215 of the limiting section 212 to form a position, and return to the state of normally closed and avoiding accidental opening.

With the structure and operation of the above-mentioned disclosure, the precision ceramic valve core 20 used in the present invention has excellent performance and durability, which can not only avoid friction loss in the rotation control, but also greatly improve the closing function. The leakproof effect at this time not only maintains the smoothness of opening, but also improves the practicality of the structure.

The precision ceramic valve core 20 cooperates with the fitting feet 223 of the shaft bolt 22 and the limiting section 212 and the rotary control section 213 inside the body 21. In the closed state, the shaft bolt 22 must be pressed to rotary open, and when the rotary control is closed from the open state, the shaft bolt 22 can also automatically rebound and position, effectively avoiding the concern that the precision ceramic valve core 20 be easily opened by the rotary control, and greatly reducing the risk of structural use that enhance the safety.

What is claimed is:

1. A precision ceramic valve with a safety device, comprising:
a valve, which is hollow and has a flow channel, a valve chamber, an inlet end, and an outlet end connected to the flow channel, the valve chamber is located at an upper end of the flow channel, an inlet path is formed at a bottom of the extension section to communicate with the flow channel and the inlet end, and an outlet path is provided at a side of the bottom of the extension section to communicate with the outlet end;
a precision ceramic valve core assembled in the valve chamber, the precision ceramic valve core has a body, a shaft bolt, a shaft bolt connecting seat, a rectifier seat, a cut control ceramic sheet, an inlet ceramic sheet, and a leakproof gasket; the body is provided with a through groove through the upper and lower ends, the upper half of the through groove is provided with a limiting section, a rotary control section, and an expansion section between the limiting section and the rotary control section; two limiting grooves are recessed at two symmetrical positions of the limiting section, and a retaining wall is formed at the upper end of the two limiting grooves; two rotary control grooves are recessed in two symmetrical positions of the rotation control section, and two rotary control blocks are formed between the two rotary control grooves; one end of the two rotary control grooves is connected to the two limit grooves, the other end of the two rotary control grooves faces the bottom surface of the limiting section, and the inner diameter of the rotary control groove is the same as that of the limiting groove; an inlet is formed at the bottom of the through groove, and two outlets and two recessed grooves are provided at symmetrical positions of the lower half of the through groove; the inner wall of the inlet forms an expansion section, and the inner wall of the expansion section is provided with a ring convex rib; the shaft bolt is passed through the through groove from bottom to top, the bottom end of the shaft bolt is recessed with a through groove to accommodate a spring, two fitting feet are formed at the bottom end of the shaft bolt extending along the edge of the through groove, and the outer surfaces of the two fitting feet exceed the surface of the shaft bolt to form a resisting portion; the outer diameter of the resisting section is larger than the inner diameter of the limiting section and is smaller than the inner diameter of the limiting groove and the rotary control groove; the shaft bolt connection seat is provided with two ring diameters on the outer diameter and is covered with two leakproof rings; the top of the shaft bolt connection seat has a connection part, the connection part is hollow with a slot for accommodating the other end of the spring and is provided with two fitting slots on the outer periphery to engage with the two fitting feet of the shaft bolt; the bottom end of the shaft bolt connection seat is further provided with a driving bump; the rectifier seat is provided with a linked through hole through the upper surface to connect with the driving bump, and two insert parts protrude from the periphery of the bottom surface; the upper surface of the cut control ceramic sheet is provided with a linked slot that fits and interlocks with the drive bump; two insert sides are formed symmetrically on both sides for two insert parts to snap together, and the bottom of the cut control ceramic sheet is symmetrically provided with two through slots and is provided with two convex blocks on the outer peripheral surface; the inlet ceramic sheet is positioned by fitting the two convex blocks with the two recessed grooves of the through groove, and is close to the bottom of the cut control ceramic sheet; the leakproof gasket is a tight plug located at the inlet of the through groove.

2. The precision ceramic valve with the safety device of claim 1, wherein, the outer diameter of the shaft bolt connection seat is larger than the inner diameter of the rotation control section, thereby limiting the shaft bolt connection seat to the bottom of the rotation control section; a lubricating washer is further provided between the shaft bolt connection seat and the rotary control section.

3. The precision ceramic valve with the safety device of claim 1, wherein, the inner wall of the inlet forms an expansion section, and the inner wall of the expansion section is provided with a ring convex rib; the leakproof gasket is provided with an annular groove on the outer diameter and is positioned through the annular groove and the ring convex rib.

4. The precision ceramic valve with the safety device of claim 1, wherein, an inner diameter of the valve chamber is reduced from top to bottom to form an internal thread section and an extension section, an inlet path is formed at the bottom of the extension section to communicate with the flow channel and the inlet end, and an outlet path is provided at the side of the bottom of the extension section to communicate with the outlet end; the outer diameter of the body decreases sequentially from top to bottom to form a nut section, an external thread section, a leakproof section, and an inlet/outlet section; the leakproof section is provided with at least two annular grooves and at least two leakproof rings embedded in the two annular grooves; the leakproof section is close to the inner diameter surface of the extension section.

5. The precision ceramic valve with the safety device of claim 4, wherein, a trench is carved on the outer diameter surface of the nut section, marking the external thread section of the body as the left-hand thread.
